(19) United States
(12) Patent Application Publication
(10) Pub. No.: US 2022/0207694 A1
(43) Pub. Date: Jun. 30, 2022

(54) IMAGE PROCESSING APPARATUS, IMAGE PROCESSING METHOD, NON-TRANSITORY COMPUTER READABLE RECORDING MEDIUM STORING AN IMAGE PROCESSING PROGRAM

(71) Applicant: KYOCERA Document Solutions Inc., Osaka (JP)

(72) Inventors: Rui Hamabe, Osaka (JP); Kazunori Tanaka, Osaka (JP); Kanako Morimoto, Osaka (JP); Takuya Miyamoto, Osaka (JP); Koji Sato, Osaka (JP)

(21) Appl. No.: 17/555,871

(22) Filed: Dec. 20, 2021

(30) Foreign Application Priority Data
Dec. 28, 2020 (JP) 2020-218476

(51) Int. Cl. G06T 7/00

(52) U.S. Cl. CPC G06T 7/0002; G06T 2207/30144; G06T 2207/10024

(57) ABSTRACT

An image processing apparatus includes an anomaly detecting unit, and an anomaly unification processing unit. The anomaly detecting unit is configured to detect anomalies included in a target image. The anomaly unification processing unit is configured to unify specific anomalies among the detected anomalies. Further, if a type of an anomaly among the detected anomalies is the same as a type of another anomaly among the detected anomalies, the anomaly unification processing unit (a) determines whether the anomaly and the other anomaly should be unified or not on the basis of a relationship between a position of the anomaly and a position of the other anomaly, and (b) unifies the anomaly and the other anomaly if it is determined that the anomaly and the other anomaly should be unified.

### CROSS-REFERENCE TO RELATED APPLICATIONS

This application relates to and claims priority rights from Japanese Patent Application No. 2020-218476, filed on Dec. 28, 2020, the entire disclosures of which are hereby incorporated by reference herein.

### BACKGROUND

### 1. Field of the Present Disclosure

The present disclosure relates to an image processing apparatus, an image processing method, and a non-transitory computer readable recording medium storing an image processing program.

### 2. Description of the Related Art

On the basis of an image obtained by scanning a printed matter outputted by an image forming apparatus such as multi function peripheral or printer, an image processing apparatus detects anomalies such as unintended line, dot and/or density unevenness that appear on the printed matter, and estimates a cause of each of the anomalies.

When detecting the aforementioned anomalies, even though one anomaly originally occurs, such anomaly may be incorrectly detected as plural anomalies if an image of the anomaly that appears in a target image includes an intermittent part. For example, in case of an intermittent line anomaly, even though this anomaly is originally one anomaly, it may be incorrectly detected as plural line anomalies.

As mentioned, if an originally single anomaly is detected as plural anomalies, a post process such as estimation of cause of anomaly is performed individually for each of the detected plural anomalies, and it results in unnecessary computation cost and long processing time. Although such anomaly that should be detected as single anomaly but detected as plural anomalies can be found and unified by manual operation, it is not realistic due to operational burden and long required time.

### SUMMARY

An image processing apparatus according to an aspect of the present disclosure includes an anomaly detecting unit, and an anomaly unification processing unit. The anomaly detecting unit is configured to detect anomalies included in a target image. The anomaly unification processing unit is configured to unify specific anomalies among the detected anomalies. Further, if a type of an anomaly among the detected anomalies is the same as a type of another anomaly among the detected anomalies, the anomaly unification processing unit (a) determines whether the anomaly and the other anomaly should be unified or not on the basis of a relationship between a position of the anomaly and a position of the other anomaly, and (b) unifies the anomaly and the other anomaly if it is determined that the anomaly and the other anomaly should be unified.

An image processing method according to an aspect of the present disclosure includes an anomaly detecting step, and an anomaly unification step. The anomaly detecting step detects anomalies included in a target image. The anomaly unification step unifies specific anomalies among the detected anomalies. Further, in the anomaly unification step, if a type of an anomaly among the detected anomalies is the same as a type of another anomaly among the detected anomalies, (a) it is determined whether the anomaly and the other anomaly should be unified or not on the basis of a relationship between a position of the anomaly and a position of the other anomaly, and (b) the anomaly and the other anomaly are unified if it is determined that the anomaly and the other anomaly should be unified.

A non-transitory computer readable recording medium according to an aspect of the present disclosure stores an image processing program; and the image processing program causes a computer to act as the aforementioned anomaly detecting unit, and the aforementioned anomaly unification processing unit.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing apparatus according to an embodiment of the present disclosure;

FIG. 2 shows a flowchart that explains a behavior of the image processing apparatus shown in FIG. 1;

FIG. 3 shows a flowchart that explains an anomaly unification process (Step S3) in FIG. 2; and

FIG. 4 shows a diagram that explains an example of the anomaly unification process (Step S3) in FIG. 2.

### DETAILED DESCRIPTION

Hereinafter, an embodiment according to an aspect of the present disclosure will be explained with reference to drawings.

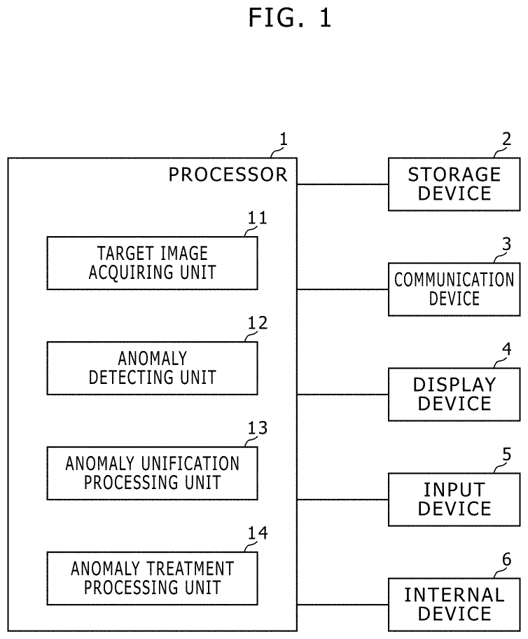

FIG. 1 shows a block diagram that indicates a configuration of an image processing apparatus according to an embodiment of the present disclosure. An image processing apparatus shown in FIG. 1 is an information processing apparatus such as personal computer or server, or an electronic apparatus such as digital camera or image forming apparatus (scanner, multi function peripheral or the like), and includes a processor 1, a storage device 2, a communication device 3, a display device 4, an input device 5, an internal device 6 and the like.

The processor 1 includes a computer and executes an image processing program using the computer and thereby acts as sorts of processing units. Specifically, the computer includes a CPU (Central Processing Unit), a ROM (Read Only Memory), a RAM (Random Access Memory) and the like, loads the image processing program stored in a non-transitory computer readable recording medium such as the ROM or the storage device 2 to the RAM, executes the image processing program using the CPU and thereby acts as predetermined processing units. Further, the processor 1 may include an ASIC (Application Specific Integrated Circuit) that acts as a specific processing unit.

The storage device 2 is a non-volatile storage device such as flash memory, and stores the image processing program and data required for a process mentioned below. The image processing program is, for example, stored in a non-transitory computer readable recording medium and installed into the storage device 2 from the recording medium.

The communication device 3 is a device that performs data communication with an external device, such as network interface or a peripheral device interface. The display device 4 is a device that displays sorts of information to a user, such as a display panel of a liquid crystal display. The input device 5 is a device that detects a user operation, such as keyboard or touch panel.

The internal device 6 is a device that performs a specific function of this image processing apparatus. For example, if this image processing apparatus is an image forming apparatus, the internal device 6 is an image scanning device that optically scans a document image from a document, a printing device that prints an image on a print sheet, or the like.

Here, the processor 1 acts as a target image acquiring unit 11, an anomaly detecting unit 12, an anomaly unification processing unit 13, and an anomaly treatment processing unit 14, as the aforementioned processing units.

The target image acquiring unit 11 acquires a target image (image data) from the storage device 2, the communication device 3, the internal device 6 or the like, and stores the target image into the RAM or the like.

The anomaly detecting unit 12 detects an anomaly included in the acquired target image in accordance with an existent method. In this embodiment, for example, the anomaly detecting unit 12 detects an anomaly using a filter (second derivative filter, Gabor filter or the like) and generates characteristic information of the detected anomaly. Specifically, an anomaly is detected on the basis of a characteristic amount (filter output) obtained by applying the filter to the input image (target image).

The characteristic information includes (a) a position and a size of the anomaly (a position and a size of a detection area mentioned below), (b) a type of the anomaly (such as line, band or dot), (c) an anomaly level corresponding to an output value of the filter when the anomaly is detected, and (d) color information. For example, when a density difference between the anomaly and a periphery of the anomaly is large, the anomaly level gets high. As the type of the anomaly, there is line (vertical line or horizontal line), band (vertical band or horizontal band), dot, pattern and the like.

The anomaly unification processing unit 13 unifies plural specific anomalies that satisfy a predetermined unification condition mentioned below, among the detected anomalies to be a single anomaly, and replaces the plural specific anomalies with the single anomaly.

Specifically, if a type of an anomaly among the detected anomalies is the same as a type of another anomaly among the detected anomalies, the anomaly unification processing unit 13 (a) determines whether the anomaly and the other anomaly should be unified or not on the basis of a relationship between a position of the anomaly and a position of the other anomaly, and (b) unifies the anomaly and the other anomaly to be a single anomaly if it is determined that the anomaly and the other anomaly should be unified. It should be noted that a type of the single anomaly obtained by the unification is set so as to be the same as the type of the unified anomalies.

In this embodiment, the anomaly unification processing unit 13 determines whether the anomaly and the other anomaly should be unified or not on the basis of a distance between a detection area of the anomaly and a detection area of the other anomaly. Specifically, if this distance is equal to or less than a predetermined threshold value, the both anomalies are unified; and otherwise, if not, the both anomalies are not unified.

It should be noted that the detection area is a rectangle area including an anomaly, and determined by the anomaly detecting unit 12.

Further, in this embodiment, if both the type of the anomaly and the type of the other anomaly are a predetermined type (a type of an anomaly of which different shapes appear in different directions; e.g. line or the like), the anomaly unification processing unit 13 determines whether the anomaly and the other anomaly should be unified or not on the basis of (a) a distance between a detection area of the anomaly and a detection area of the other anomaly and (b) a direction of the anomaly and a direction of the other anomaly. Specifically, if this distance is equal to or less than a predetermined threshold value, and a difference between directions of the both anomalies (i.e. angle difference) is equal to or less than a predetermined threshold value, the both anomalies are unified; and otherwise, if not, the both anomalies are not unified. Regarding the both anomalies that have different types, even if the distance between the both anomalies or the directions of the both anomalies satisfies the aforementioned condition, the both anomalies are not unified.

Furthermore, in this embodiment, when unifying the anomaly and the other anomaly, the anomaly unification processing unit 13 sets color information of an anomaly obtained by unifying the anomaly and the other anomaly (i.e. a color value at the anomaly part) on the basis of color information of the anomaly and color information of the other anomaly.

For example, color information (a color value) of an anomaly obtained by unifying the anomaly and the other anomaly is a weighted average based on weighting factors corresponding to the detection areas of the anomaly and the other anomaly.

Furthermore, in this embodiment, when unifying the anomaly and the other anomaly, the anomaly unification processing unit 13 sets an anomaly level of an anomaly obtained by unifying the anomaly and the other anomaly on the basis of an anomaly level of the anomaly and an anomaly level of the other anomaly.

For example, the anomaly level of an anomaly obtained by unifying the anomaly and the other anomaly is set as the largest value among the anomaly levels of the anomaly and the other anomaly.

In addition, if there is another anomaly that satisfies the unification condition with the anomaly obtained by the unification, then unification is further performed of both this other anomaly and the anomaly obtained by the unification. Therefore, if three or more anomalies are arranged and each of the three or more anomalies satisfies the unification condition, then the three or more anomalies are unified to be a single anomaly.

The anomaly treatment processing unit 14 performs a predetermined anomaly treatment process for the detected anomaly. Specifically, the anomaly treatment process is not performed for plural original anomalies unified to be a single anomaly, but the anomaly treatment process is performed for this single anomaly obtained by the unification. The anomaly treatment process is notification of the detected anomaly (such as message transmission from the communication device 3 or displaying a message on the display device 4 to an operator who is engaged in maintenance or determination of a malfunction part corresponding to the detected anomaly), automatic determination of a malfunction part corresponding to the detected anomaly, an automatic maintenance operation, and/or the like.

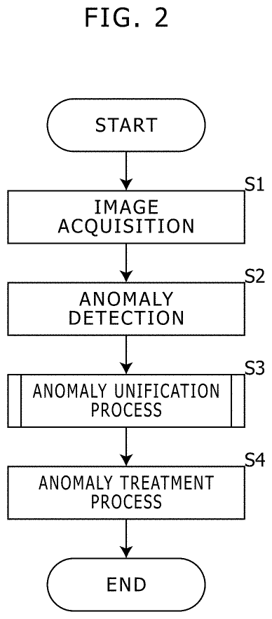

The following part explains a behavior of the image processing apparatus in FIG. 1. FIG. 2 shows a flowchart that explains a behavior of the image processing apparatus shown in FIG. 1.

Firstly, the target image acquiring unit 11 acquires a target image (image data) (in Step S1). Subsequently, the anomaly detecting unit 12 detects an anomaly included in the acquired target image, generates characteristic information (position-and-size information, type, anomaly level, color information and the like) of the detected anomaly, and stores the characteristic information into the RAM or the like (in Step S2).

Subsequently, the anomaly unification processing unit performs an anomaly unification process that unifies specific anomalies among the detected anomalies (in Step S3).

The anomaly treatment processing unit 14 performs a predetermined anomaly treatment process for the detected anomaly (including an anomaly obtained by the anomaly unification process) (in Step S4).

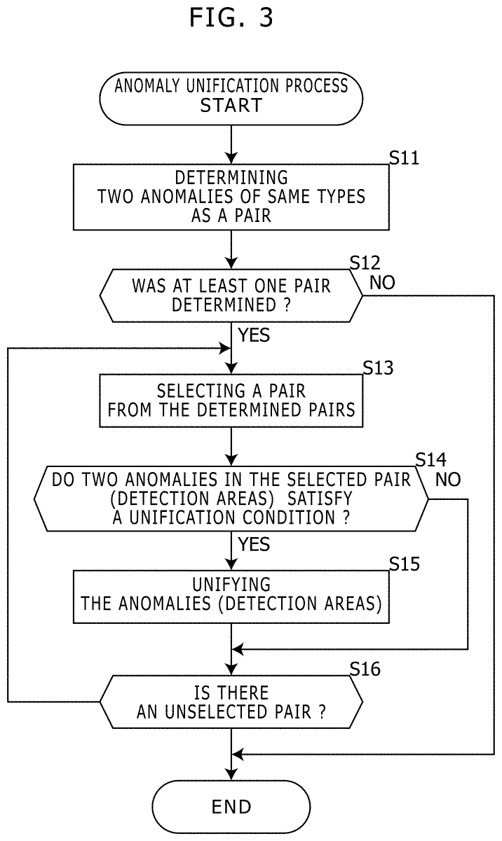

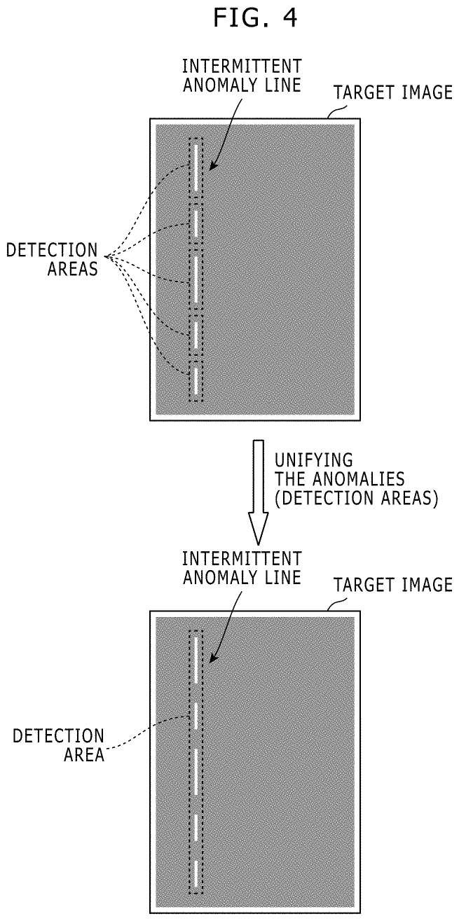

Here explained is the anomaly unification process in Step S3. FIG. 3 shows a flowchart that explains the anomaly unification process (Step S3) in FIG. 2. FIG. 4 shows a diagram that explains the example of the anomaly unification process (Step S3) in FIG. 2.

The anomaly unification processing unit 13 firstly determines, as a pair, two anomalies that have the same types among the detected anomalies (in Step S11).

Here, the anomaly unification processing unit 13 determines whether at least one pair was determined or not (in Step S12); and if at least one pair was determined, the anomaly unification processing unit 13 selects a pair among the determined pairs of anomalies (in Step S13), and determines whether two anomalies in the selected pair satisfy the aforementioned unification condition or not (in Step S14).

If the two anomalies in the selected pair satisfy the aforementioned unification condition, the anomaly unification processing unit 13 unifies the two anomalies in the selected pair to be a single anomaly (in Step S15). Otherwise, if the two anomalies in the selected pair do not satisfy the aforementioned unification condition, the anomaly unification processing unit 13 does not unify the two anomalies in the selected pair to be a single anomaly.

In this process, the anomaly unification processing unit 13 sets a circumscribed rectangle of the detection areas of the two anomalies in the selected pair as a detection area of the anomaly obtained by the unification, sets an anomaly level of the aforementioned anomaly obtained by the unification on the basis of anomaly levels of the two anomalies in the selected pair, and sets color information of the aforementioned anomaly obtained by the unification on the basis of color information of the two anomalies in the selected pair. Further, the anomaly unification processing unit 13 additionally determines a pair of the anomaly obtained by the unification and another anomaly having the same type, if there is such another anomaly.

Subsequently, the anomaly unification processing unit 13 determines whether there is an unselected pair or not (in Step S16); and if there is an unselected pair, returning to Step S13, the anomaly unification processing unit 13 selects a next pair and performs a process in and subsequent to Step S14 as well. If there are no unselected pairs, the anomaly unification processing unit 13 terminates the anomaly unification process.

As mentioned, among the detected anomalies, specific anomalies are unified if the specific anomalies satisfy the unification condition. It should be noted that in Step S12, if no pairs are determined, then the anomaly unification processing unit 13 immediately terminates the anomaly unification process.

For example, as shown in FIG. 4, even if an originally single intermittent anomaly line is detected as plural anomaly lines, the anomaly unification process unifies the plural anomaly lines to be a single anomaly line.

As mentioned, in the aforementioned embodiment, the anomaly detecting unit 12 detects anomalies included in a target image, and the anomaly unification processing unit 13 unifies specific anomalies among the detected anomalies. Further, if a type of an anomaly among the detected anomalies is the same as a type of another anomaly among the detected anomalies, the anomaly unification processing unit (a) determines whether the anomaly and the other anomaly should be unified or not on the basis of a relationship between a position of the anomaly and a position of the other anomaly, and (b) unifies the anomaly and the other anomaly if it is determined that the anomaly and the other anomaly should be unified.

Consequently, even if one original anomaly is detected as plural anomalies, the plural line anomalies are unified to be a single line anomaly; and therefore, the number of times of the anomaly treatment process for each anomaly is reduced, and computation cost and processing time are restrained.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the aforementioned threshold value for the distance may be set independently to each of types of anomalies.

Further, in the aforementioned embodiment, the aforementioned image processing program may be stored in a potable recording medium (non-transitory computer readable recording medium), and installed from this recording medium to the storage device 2.

What is claimed is:

1. An image processing apparatus, comprising:
an anomaly detecting unit configured to detect anomalies included in a target image; and
an anomaly unification processing unit configured to unify specific anomalies among the detected anomalies;
wherein if a type of an anomaly among the detected anomalies is the same as a type of another anomaly among the detected anomalies, the anomaly unification processing unit (a) determines whether the anomaly and the other anomaly should be unified or not on the basis of a relationship between a position of the anomaly and a position of the other anomaly, and (b) unifies the anomaly and the other anomaly if it is determined that the anomaly and the other anomaly should be unified.

2. The image processing apparatus according to claim 1, wherein the anomaly unification processing unit determines whether the anomaly and the other anomaly should be unified or not on the basis of a distance between a detection area of the anomaly and a detection area of the other anomaly.

3. The image processing apparatus according to claim 1, wherein if both the type of the anomaly and the type of the other anomaly are a predetermined type, the anomaly unification processing unit determines whether the anomaly and the other anomaly should be unified or not on the basis of (a) a distance between a detection area of the anomaly and a detection area of the other anomaly and (b) a direction of the anomaly and a direction of the other anomaly.

4. The image processing apparatus according to claim 1, wherein when unifying the anomaly and the other anomaly, the anomaly unification processing unit sets color information of an anomaly obtained by unifying the anomaly and the other anomaly on the basis of color information of the anomaly and color information of the other anomaly.

5. The image processing apparatus according to claim 1, wherein
the anomaly detecting unit detects the anomalies using a filter and generates characteristic information of each of the anomalies;
the characteristic information includes a type of the anomaly and an anomaly level corresponding to an output value of the filter when the anomaly is detected; and
when unifying the anomaly and the other anomaly, the anomaly unification processing unit sets an anomaly level of an anomaly obtained by unifying the anomaly and the other anomaly on the basis of an anomaly level of the anomaly and an anomaly level of the other anomaly.

6. An image processing method, comprising:
an anomaly detecting step that detects anomalies included in a target image; and
an anomaly unification step that unifies specific anomalies among the detected anomalies;
wherein in the anomaly unification step, if a type of an anomaly among the detected anomalies is the same as a type of another anomaly among the detected anomalies, (a) it is determined whether the anomaly and the other anomaly should be unified or not on the basis of a relationship between a position of the anomaly and a position of the other anomaly, and (b) the anomaly and the other anomaly are unified if it is determined that the anomaly and the other anomaly should be unified.

7. A non-transitory computer readable recording medium storing an image processing program,
wherein the image processing program causes a computer to act as an anomaly detecting unit configured to detect anomalies included in a target image; and an anomaly unification processing unit configured to unify specific anomalies among the detected anomalies; and
if a type of an anomaly among the detected anomalies is the same as a type of another anomaly among the detected anomalies, the anomaly unification processing unit (a) determines whether the anomaly and the other anomaly should be unified or not on the basis of a relationship between a position of the anomaly and a position of the other anomaly, and (b) unifies the anomaly and the other anomaly if it is determined that the anomaly and the other anomaly should be unified.
